(19) United States
(12) Patent Application Publication
(10) Pub. No.: US 2026/0186720 A1
(43) Pub. Date: Jul. 2, 2026

(54) INFORMATION PROCESSING SYSTEM, NON-TRANSITORY COMPUTER READABLE MEDIUM AND INFORMATION PROCESSING METHOD

(71) Applicant: FUJIFILM Business Innovation Corp., Tokyo (JP)

(72) Inventors: Bo LIU, Kanagawa (JP); Kimihiko SASAKI, Kanagawa (JP); Naoto YAMASAKI, Kanagawa (JP); Kazuki NAGASHIMA, Kanagawa (JP)

(73) Assignee: FUJIFILM Business Innovation Corp., Tokyo (JP)

(21) Appl. No.: 19/285,388

(22) Filed: Jul. 30, 2025

(30) Foreign Application Priority Data
Dec. 27, 2024 (JP) 2024-232972

(51) Int. Cl. G06F 3/12

(52) U.S. Cl. CPC G06F 3/1275; G06F 3/1207

(57) ABSTRACT

An information processing system includes a processor configured to: when a processing procedure including multiple processing steps to process a workpiece has been produced, cause to be displayable, on a display, pre-process information indicating the workpiece and post-process information indicating a product obtained when the processing procedure is performed on the workpiece.

### CROSS-REFERENCE TO RELATED APPLICATIONS

This application is based on and claims priority under 35 USC 119 from Japanese Patent Application No. 2024-232972 filed Dec. 27, 2024.

### BACKGROUND

### (i) Technical Field

The present disclosure relates to an information processing system, a non-transitory computer readable medium and an information processing method.

### (ii) Related Art

Japanese Unexamined Patent Application Publication No. 2012-160090 discloses a print setting edit program that causes a computer to operate as a first unit and a second unit. The first unit causes a display to display a job edit screen including a preview region and an exception page setting region. The preview region is used to display on a per sheet unit basis a finished preview that results from performing print setting on input document data. The exception page setting region is used to set an exception on the page setting on a per sheet unit basis. The second unit attaches, to a preview corresponding to the sheet with the exception set on the print setting out of previews displayed on the preview region, information indicating that the exception has been set on the print setting and the second unit causes the information to be displayed.

Japanese Unexamined Patent Application Publication No. 2020-149590 discloses an information processing apparatus that includes a production unit, first receiving unit, first preview display unit, second receiving unit, and second preview receiving unit. The production unit produces, on each type of product, a workflow including multiple operation steps to produce a product. The first receiving unit receives a setting of a parameter of the operation step in response to user operation. The first preview display unit displays a preview using the setting received by the first receiving unit and predetermined dummy data. The second receiving unit receives a designate of a single piece of original document data from multiple pieces of original document data. The second preview display unit displays a preview with the dummy data substituted for the original document datum.

One contemplated information system may produce a processing procedure including multiple processing steps, including a processing step to process a workpiece (like as a print image to be printed) (for example, adding barcode, water mark, page number, and the like, and imposition). When the processing procedure is completed, a product that results from processing a workpiece and the workpiece may be compared in terms of physical object (such as printed materials). In this case, each time the processing procedure is reviewed, the physical object may be produced (for example, a printed material is actually printed out), taking time and effort.

### SUMMARY

Aspects of non-limiting embodiments of the present disclosure relate to facilitating comparison of a workpiece and a product in comparison with the case in which a workpiece and a product resulting from performing a processing procedure on the workpiece are compared in terms of a physical object.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: when a processing procedure including multiple processing steps to process a workpiece has been produced, cause to be displayable, on a display, pre-process information indicating the workpiece and post-process information indicating a product obtained when the processing procedure is performed on the workpiece.

### BRIEF DESCRIPTION OF THE DRAWINGS

Exemplary embodiment of the present disclosure will be described in detail based on the following figures, wherein:

FIG. 1 is a block diagram illustrating an example of the hardware configuration of an information processing system of an exemplary embodiment;

FIG. 2 is a block diagram illustrating an example of the functional configuration of an information processing apparatus of the exemplary embodiment;

FIG. 3 is a flowchart illustrating a procedure of an information processing process performed by the information processing system of the exemplary embodiment;

FIG. 4 illustrates an example of a production screen displayed on a display of the exemplary embodiment;

FIG. 5 illustrates an example of the selection screen displayed on the display of the exemplary embodiment;

FIG. 6 illustrates an example of the preview screen displayed on the display of the exemplary embodiment; and

FIG. 7 illustrates the state in which workflow data, output data, and test data are displayed on the preview screen illustrated in FIG. 6.

### DETAILED DESCRIPTION

Example of an exemplary embodiment of the disclosure is described below with reference to the drawings.

### Information Processing System 10

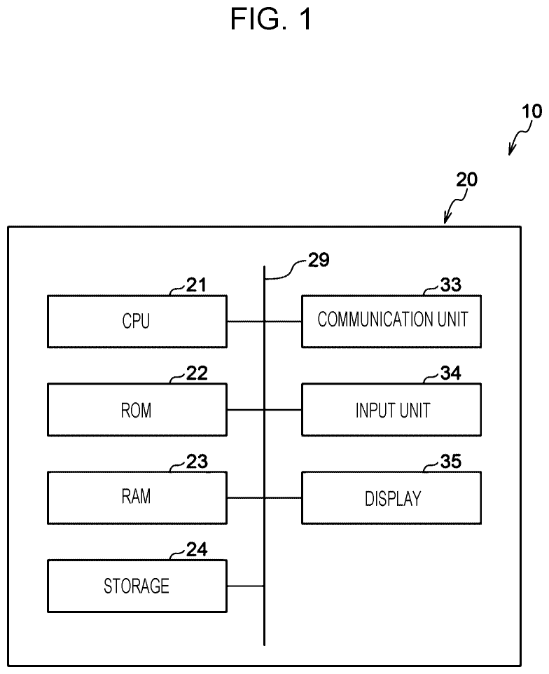

Information processing system 10 of the exemplary embodiment is described below. FIG. 1 is a block diagram illustrating an example of the hardware configuration of the information processing system 10 of the exemplary embodiment.

The information processing system 10 illustrated in FIG. 1 performs a predetermined information processing process. According to the exemplary embodiment, the information processing system 10 performs a production operation that produces a workflow in a pre-process of printing. When the workflow is produced, the information processing system 10 performs an operation to cause to be displayable image data that indicates a print image after the execution of the workflow.

The information processing system 10 includes, for example, an information processing apparatus 20. The information processing apparatus 20 may be a general-purpose computer, such as a server computer or a personal computer.

The information processing apparatus 20 has a function of a computer and includes, as illustrated in FIG. 1, a central processing unit (CPU) 21, read-only memory (ROM) 22, random-access memory (RAM) 23, storage 24, communication unit 33, input unit 34, and display 35.

The CPU 21, ROM 22, RAM 23, storage 24, communication unit 33, input unit 34 and display 35 are interconnected to each other via a connection line 29. The information processing system 10 may include a single information processing apparatus 20 or multiple information processing apparatuses 20. The process performed by the single information processing apparatus 20 may also be performed by the multiple information processing apparatuses 20.

The communication unit 33 is a communication interface and is thus configured to communicate with the other apparatus. Specifically, the communication unit 33 communicates with the other apparatus via at least one of a wired communication line or a wireless communication line.

The other apparatus may be a providing apparatus that provides the information processing apparatus 20 with image information representing a print image. The other apparatus may be a converter that converts image data, obtained when the information processing apparatus 20 has performed the workflow on the image data, into image data which a printer is able to print. When the information processing apparatus 20 is able to convert the image data having undergone the workflow into the image data that is printable by a printer, the other apparatus may be the printer.

The input unit 34 is configured to receive an instruction from a user. Specifically, the input unit 34 includes input keys (such as a keyboard, mouse and/or operation button) with which the user performs an input action. The user is an example of a user of the information processing system 10.

The display 35 notifies the user of presentation information by displaying the presentation information for the user on the display 35. The display 35 is, for example, a liquid-crystal display or an organic electroluminescence (EL) display. A variety of screens may be displayed on the display 35.

The display 35 may operate as the input unit 34. In such a case, the input unit 34 is configured to include a touch panel of a resistive membrane system or an electrostatic capacitance system and receives an instruction from the user when the user performs a touch operation.

The CPU 21 is an arithmetic processing unit and executes a variety of programs including an information processing program and controls each unit in the information processing apparatus 20. The ROM 22 stores the variety of programs including the information processing program and a variety of data. The RAM 23 operating as a working area stores temporarily programs and data. The storage 24 includes a recording medium, such as a hard-disk drive (HDD), solid-state drive (SSD) or flash memory and stores a variety of programs including an operating system and a variety of data. The information processing program may also be stored on the storage 24.

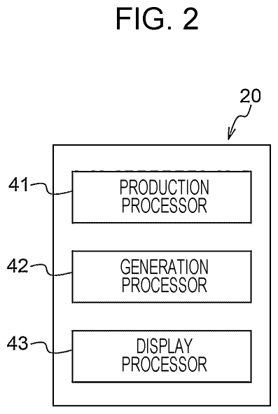

The CPU 21 in the information processing apparatus 20 retrieves the variety of programs including the information processing program from the ROM 22 or the storage 24 and executes the programs using the RAM 23 as a working area. A variety of functions are implemented by the CPU 21 that executes the information processing program. As described below, a functional configuration is implemented when the CPU 21 serving as a hardware resource and the information processing program serving as a software resource operate in concert with each other. FIG. 2 is a block diagram illustrating an example of the functional configuration of the information processing apparatus 20 of the exemplary embodiment.

The CPU 21 in the information processing apparatus 20 operates as a production processor 41, generation processor 42, and display processor 43 as illustrated in FIG. 2 when the CPU 21 executes the information processing program.

The production processor 41 performs a workflow production operation that produces a workflow in a pre-process of printing. According to the exemplary embodiment, the “workflow” is a procedure of a process in a prepress and includes multiple treatment steps to process a print image. The print image serves as an example of a workpiece. The treatment step is an example of a processing step. The workflow is an example of a processing procedure.

The “production of the workflow” is not limited to the case in which the workflow is produced from scratch and also includes other cases, for example, a case in which a produced workflow is retrieved from the storage 24 and then edited. A specific workflow production operation (step S101) is described below.

The generation processor 42 performs a generation operation (as illustrated below with reference to step S106) to generate image data. In the generation operation, the generation processor 42 performs a workflow on test data, thereby generating image data of an print image that has undergone the workflow.

The display processor 43 performs a display operation (step S113 described below). In the display operation as described below, the display processor 43 displays on the display 35 output data that indicates a print image processed when the workflow is performed on the image data and test data that indicates a print image before the workflow is performed. The processed print image is an example of a product having undergone processing. The output data is an example of post-process information. The test data is an example of pre-process information.

### Information Processing Process of Exemplary Embodiment

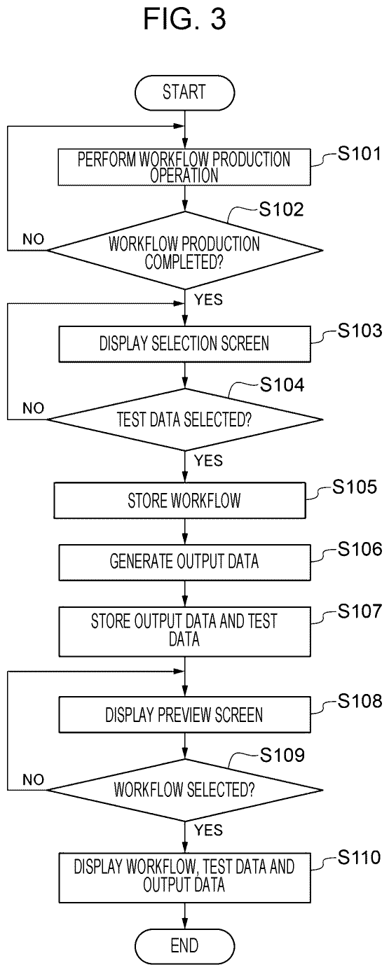

Example of the information processing process performed by the information processing system 10 is described below. FIG. 3 is a flowchart illustrating the procedure of the information processing process performed by the information processing system 10. The information processing process produces a workflow in a pre-process of printing and causes to be displayable image data indicating print images prior to and subsequent to the execution of the workflow.

The execution of the information processing process starts when the CPU 21 receives a production instruction of the workflow from a user. Referring to FIG. 3, the CPU 21 first performs a workflow production operation (step S101).

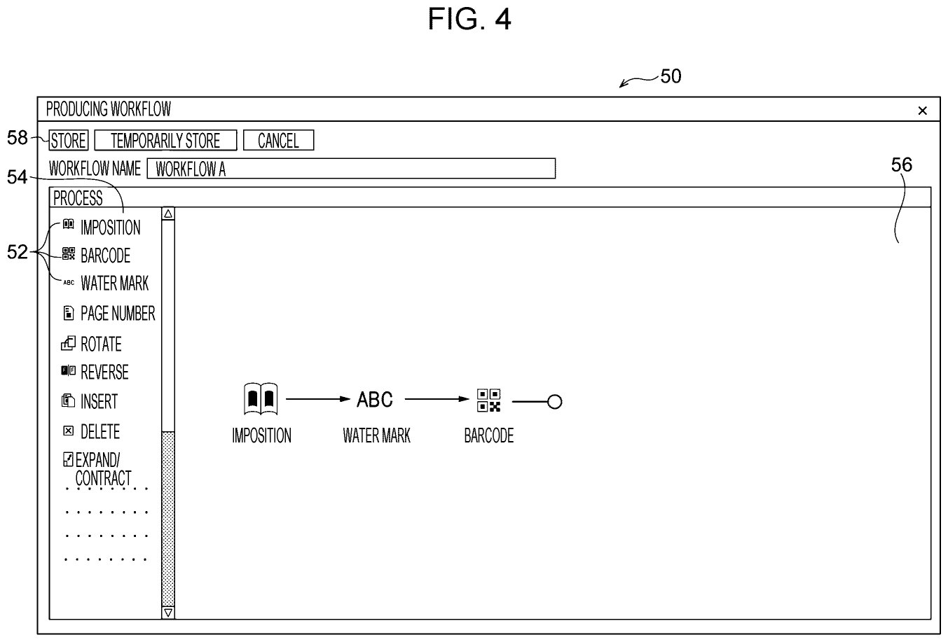

In the workflow production operation, the CPU 21 displays a production screen 50 (see FIG. 4) on the display 35. FIG. 4 illustrates an example of the production screen 50 displayed on the display 35. When the user enters an instruction on the production screen 50 in the workflow production operation, the CPU 21 produces the workflow in response to the instruction.

The left-end portion of the production screen 50 displays an icon list 54 including operation icons 52. The icon list 54 lists the operation icons 52 in a vertical direction.

The operation icons 52 respectively represent various treatment steps forming the workflow. In the production screen 50 illustrated in FIG. 4, the operation icons 52 include icons indicating treatment steps, such as imposition, attaching barcode, attaching watermark, attaching page number, rotate, reverse, insert, delete and expand/contract.

The imposition step is used to impose the pages of print images in a predetermined order. The barcode attachment step, watermark attachment step and page number attachment step attach a barcode, watermark and page number to the print image. The rotate step, reverse step, insert step, delete step and expand/contract step respectively rotate, reverse, insert, delete and expand/contact a predetermined page of the print images.

The right-end portion opposite to the icon list 54 on the production screen 50 serves as a workflow production region 56. For example, the CPU 21 produces the workflow when the user, by using the input unit 34, performs an input instruction that moves the operation icons 52 from the icon list 54 to the workflow production region 56 and then arranges the operation icons 52. The input action to move the operation icons 52 may be a drag and drop operation using a mouse or the like.

FIG. 4 illustrates the workflow that performs the imposition step, watermark attachment step and barcode attachment step in that order.

Referring to FIG. 3, the CPU 21 determines whether the workflow has been produced (step S102). Specifically, the CPU 21 determines that the workflow is produced when the user presses a storage button 58 on the production screen 50. Specifically, the CPU 21 performs determination depending on whether the user has pressed the storage button 58 on the production screen 50.

Upon determining that the workflow has been produced (yes in step S102), the CPU 21 proceeds to step S103.

Upon determining that the workflow has not been produced (no in step S102), the CPU 21 returns to the step S101. In other words, the CPU 21 performs the workflow production operation until the storage button 58 is pressed.

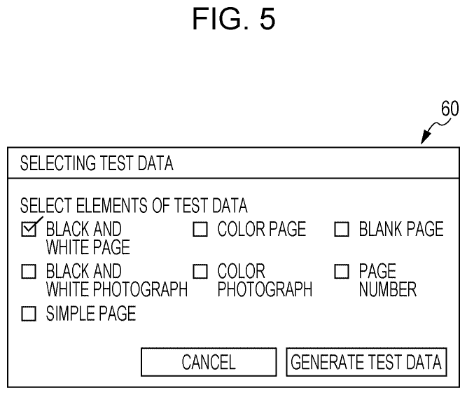

In step S103, the CPU 21 displays on the display 35 a selection screen 60 used to select the test data (see FIG. 5). FIG. 5 illustrates an example of the selection screen 60 displayed on the display 35. The user may select the test data by inputting a selection instruction on the selection screen 60.

Specifically, the user selects a piece of data from multiple pieces of the test data by checking a check box corresponding to the piece of the test data on the selection screen 60 through a click operation.

The test data is image data of a print image on which a workflow is to be performed. The test data is pre-stored by the information processing system 10. The information processing system 10 stores the multiple pieces of test data. The multiple pieces of test data are pre-stored such that the user may select any piece of test data in view of the workflow that is to be performed.

The CPU 21 determines whether the user has selected the test data on the selection screen 60 (step S104). Specifically, the CPU 21 performs determination depending on whether a check box is checked on the selection screen 60.

Upon determining that the user has selected the test data (yes in step S104), the CPU 21 stores on the storage 24 information indicative of the produced workflow (step S105). The CPU 21 performs the generation operation (step S106).

The CPU 21 performs the workflow on the test data selected by the user and thus generates image data (hereinafter referred to as output data) of a print image obtained when the workflow is performed on the print image of the test data.

The CPU 21 stores on the storage 24 the output data and test data in association with the workflow (step S107) and then proceeds to step S108. When the CPU 21 stores the output data and test data on the storage 24, the output data and test data are displayable on the display 35.

Upon determining that the user has not selected the test data (no in step S104), the CPU 21 returns to the step S103. The CPU 21 continues to display the selection screen 60 until the user checks a check box on the selection screen 60.

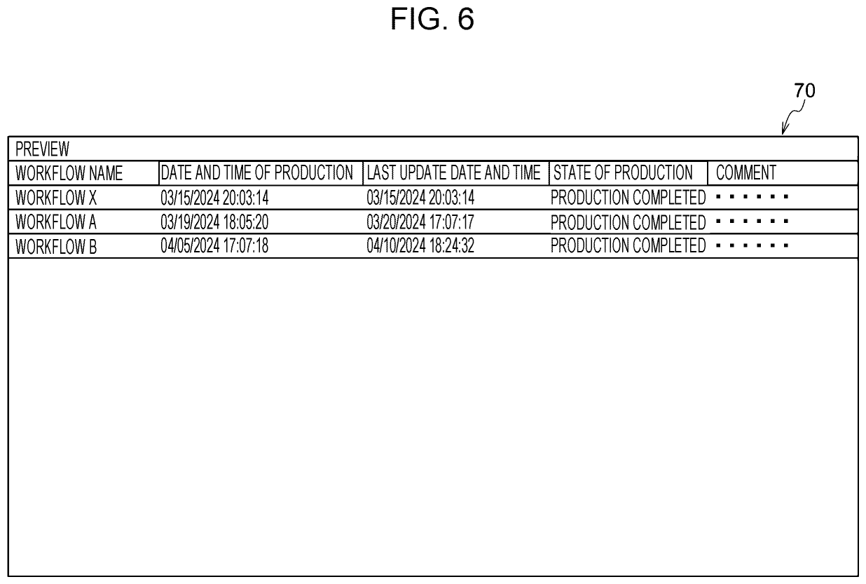

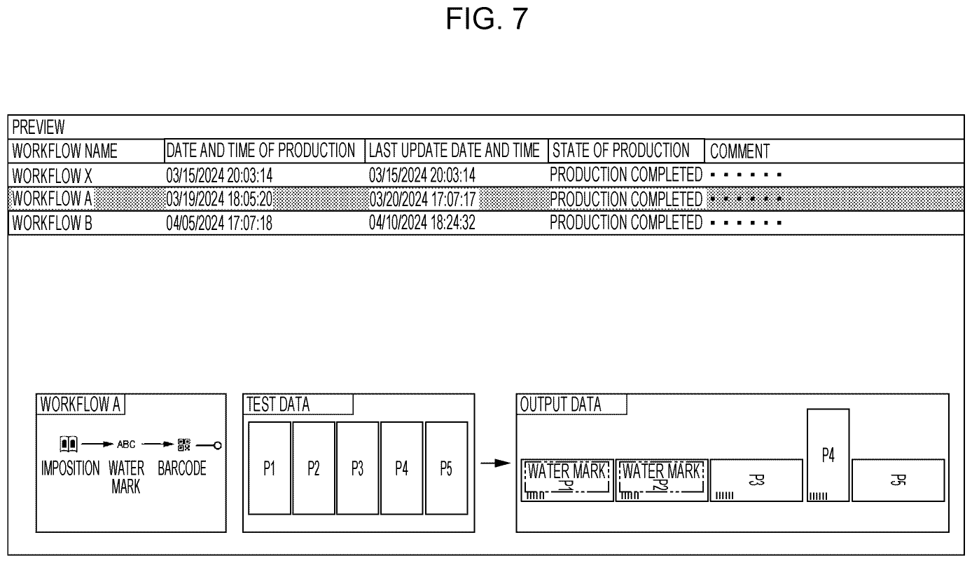

In step S108, the CPU 21 displays on the display 35 a preview screen 70 (see FIGS. 6 and 7) where a preview is displayable. FIGS. 6 and 7 illustrate examples of the preview screen 70 displayed on the display 35.

The preview screen 70 displays a list of workflows that have been produced and have undergone data selection.

The user may select a workflow used to display a preview by inputting a selection instruction to select the workflow. Specifically, the user may select a workflow from multiple workflows by performing a click operation on the preview screen 70.

FIG. 6 illustrates the preview screen 70 in the state before a workflow is selected. FIG. 7 illustrates the preview screen 70 in the state after a workflow is selected.

The CPU 21 determines whether the user has selected a workflow (step S109). Upon determining that the user has selected a workflow (yes in step S109), the CPU 21 performs a display operation (step S110).

In the display operation, the CPU 21 displays the workflow selected by the user and the test data and output data associated with the workflow (step S110). In this way, the user may determine whether the workflow is appropriate or not by comparing the test data with the output data.

According to the exemplary embodiment, in this way, the CPU 21 displays the workflow together with the test data and output data on one screen of the display 35.

When the workflow is determined to be appropriate, the user may perform a printing operation to perform printing on a recording medium, such as a paper sheet, using the workflow. When the workflow is not determined to be appropriate, the user may edit the workflow.

If the CPU 21 determines that the user has not selected the workflow (no in step S109), the CPU 21 returns to the step S108. Specifically, the CPU 21 continues to display the preview screen 70 until the user selects a workflow on the preview screen 70.

### Process of Exemplary Embodiment

When the production of workflow is completed in the exemplary embodiment, the CPU 21 causes the output data and test data to be displayable on the display 35 as described above.

The print image of the test data may be more easily compared with the print image of the output data than when printed materials are used to compare the print image of the test data with the print image of the output data.

The test data pre-stored on the information processing system 10 is used in the exemplary embodiment. The number of steps may be reduced more and the comparison of the print image of the test data with the print image of the output data may be easier than when the user prepares the test data.

The CPU 21 uses a piece of test data selected from multiple pieces of test data in the exemplary embodiment. The output data resulting from performing the workflow on data similar to the image data used by the user may be compared with the test data, unlike the case in which a single piece of test data is pre-stored.

According to the exemplary embodiment, the CPU 21 stores the output data and test data in association with the workflow on the storage 24. The output data and test data may thus be displayable in association with the workflow.

When a workflow is selected from the list of produced workflows on the preview screen 70 in the exemplary embodiment, the CPU 21 displays the output data and test data associated with the selected workflow on the preview screen 70. For this reason, the output data that the user wants to compare and the test data are displayed on the display 35 in response to the selection of the workflow.

According to the exemplary embodiment, the CPU 21 displays the workflow together with the test data and output data on one screen of the display 35. The comparison of the test data and output data may be easier than when the test data and output data are displayable on different screens of the display 35. The test data, output data, and workflow may be more easily verified than when the test data, output data, and workflow are displayable on different screens of the display 35.

### Modifications of Generation Operation and Display Operation

The CPU 21 does not generate the output data in the generation operation (step S106) when a treatment step inexecutable on the print image of the test data is included in the workflow. In such a case, the CPU 21 hides the output data in the display operation (step S110). In the display operation (step S110), the CPU 21 causes to be displayable on the display 35 a notification indicating that the treatment step inexecutable on the print image of the test data is included in the workflow. For example, in the display operation (step S110), the CPU 21 may hide the output data while displaying on the display 35 an alert that the treatment step inexecutable on the print image of the test data is included in the workflow.

When the treatment step inexecutable on the print image of the test data is included in the workflow, the output data is hidden in the modification described above. The user may thus more easily recognize that the treatment step inexecutable on the print image of the test data is included in the workflow than when the output data is displayable.

The notification indicating that the treatment step inexecutable on the print image of the test data is included in the workflow is displayable on the display 35 in the exemplary embodiment. When the treatment step inexecutable on the print image of the test data is included in the workflow, the user may more easily recognize that the treatment step inexecutable on the print image of the test data is included in the workflow than when the output data is only hidden.

### Other Modifications

The test data pre-stored on the information processing system 10 is used in the exemplary embodiment. The disclosure is not limited to this method. For example, test data prepared by the user may be used.

The CPU 21 uses the piece of test data selected from the multiple pieces of test data in the exemplary embodiment. The disclosure is not limited to this method. For example, only a single piece of test data may be pre-stored and used.

The CPU 21 displays the workflow together with the test data and output data on one screen of the display 35 in the exemplary embodiment. The disclosure is not limited to this method. For example, the CPU 21 may display the test data and output data on different screens of the display 35. Also, the test data, output data, and workflow may be displayed on different screens of the display 35.

The print image is an example of the workpiece in the exemplary embodiment. The disclosure is not limited to this method. For example, an example of the workpieces may be a manufactured component forming a portion of a manufactured product and may thus be processed and used.

The print image that has been processed is an example of the product in the exemplary embodiment. The disclosure is not limited to this method. An example of the product may be a manufactured produced manufactured of manufactured components and may be processed and used.

The processing step is a processing step for printing in the exemplary embodiment. The disclosure is not limited to this method. For example, the processing step may be a manufacturing step used to manufacture a product and may be any processing step applied to the workpiece.

The disclosure is not limited to the above-described exemplary embodiment and a variety of modifications, changes, and improvements may be made without departing from the scope of the disclosure. For example, multiple modifications described above may be combined.

In the exemplary embodiment above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the exemplary embodiment above, the term “processor” is broad enough to encompass one processor or plural processors in collaboration which are located physically apart from each other but may work cooperatively. The order of operations of the processor is not limited to one described in the exemplary embodiment above, and may be changed.

The information processing system 10 of the exemplary embodiment is not limited to including the single apparatus as described above but may include multiple apparatuses. The term “system” in the exemplary embodiment may include a single apparatus or multiple apparatuses. The disclosure is applicable to not only the program but also program products.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system including:
a processor configured to:
   when a processing procedure including multiple processing steps to process a workpiece has been produced, cause to be displayable, on a display, pre-process information indicating the workpiece and post-process information indicating a product obtained when the processing procedure is performed on the workpiece.
(((2)))

In the information processing system according to (((1))), the processor is configured to cause to be displayable, on the display, the pre-process information and the post-process information indicating the product obtained when the processing procedure is performed on the workpiece indicated by the pre-process information pre-stored on the information processing system.
(((3)))

In the information processing system according to (((2))), multiple pieces of the pre-process information are pre-stored, and
wherein the processor is configured to cause to be displayable, on the display, the pre-process information and the post-process information indicating the product obtained when the processing procedure is performed on the workpiece indicated by the pre-process information selected from the multiple pieces of the pre-process information.
(((4)))

In the information processing system according to one of (((1))) through (((3))), the processor is configured to store the pre-process information and the post-process information, in association with the produced processing procedure.
(((5)))

In the information processing system according to one of (((1))) through (((4))), the processor is configured to, when the processing procedure is selected from multiple processing procedures that have been produced, display the pre-process information and the post-process information that are associated with the selected processing procedure.
(((6)))

In the information processing system according to one of (((1))) through (((5))), the processor is configured to, when a processing step that is inexecutable on the workpiece is included in the processing procedure, hide the post-process information.
(((7)))

In the information processing system according to (((6))), the processor is configured to when the processing step that is inexecutable on the workpiece is included in the processing procedure, cause to be displayable on the display a notification notifying that the processing step that is inexecutable on the workpiece is included in the processing procedure.
(((8)))

In the information processing system according to one of (((1))) through (((7))), the processor is configured to cause the pre-process information and the post-process information to be displayable on one screen of the display.
(((9)))

In the information processing system according to (((8))), the processor is configured to cause to be displayable, on the one screen of the display, the pre-process information and the post-process information together with procedure information indicating the processing procedure.
(((10)))

In the information processing system according to one of (((1))) through (((9))), the pre-process information is image information indicative of a print image serving as the workpiece, and the post-process information is image information indicative of a print image serving as the product obtained when the processing procedure is performed on the print image serving as the workpiece.
(((11)))

A program causing a computer to execute a process for processing information, the process including:
when a processing procedure including multiple processing steps to process a workpiece has been produced, causing to be displayable, on a display, pre-process information indicating the workpiece and post-process information indicating a product obtained when the processing procedure is performed on the workpiece.

What is claimed is:

1. An information processing system comprising:
a processor configured to:
when a processing procedure including a plurality of processing steps to process workpiece has been produced, cause to be displayable, on a display, pre-process information indicating the workpiece and post-process information indicating a product obtained when the processing procedure is performed on the workpiece.

2. The information processing system according to claim 1, wherein the processor is configured to cause to be displayable, on the display, the pre-process information and the post-process information indicating the product obtained when the processing procedure is performed on the workpiece indicated by the pre-process information pre-stored on the information processing system.

3. The information processing system according to claim 2, wherein a plurality of pieces of the pre-process information are pre-stored, and
wherein the processor is configured to cause to be displayable, on the display, the pre-process information and the post-process information indicating the product obtained when the processing procedure is performed on the workpiece indicated by the pre-process information selected from the plurality of pieces of the pre-process information.

4. The information processing system according to claim 1, wherein the processor is configured to store the pre-process information and the post-process information, in association with the produced processing procedure.

5. The information processing system according to claim 1, wherein the processor is configured to, when the processing procedure is selected from a plurality of the processing procedures that have been produced, display the pre-process information and the post-process information that are associated with the selected processing procedure.

6. The information processing system according to claim 1, wherein the processor is configured to, when a processing step that is inexecutable on the workpiece is included in the processing procedure, hide the post-process information.

7. The information processing system according to claim 6, wherein the processor is configured to, when the processing step that is inexecutable on the workpiece is included in the processing procedure, cause to be displayable on the display a notification notifying that the processing step that is inexecutable on the workpiece is included in the processing procedure.

8. The information processing system according to claim 1, wherein the processor is configured to cause the pre-process information and the post-process information to be displayable on one screen of the display.

9. The information processing system according to claim 8, wherein the processor is configured to cause to be displayable, on the one screen of the display, the pre-process information and the post-process information together with procedure information indicating the processing procedure.

10. The information processing system according to claim 1, wherein the pre-process information is image information indicative of a print image serving as the workpiece, and the post-process information is image information indicative of a print image serving as the product obtained when the processing procedure is performed on the print image serving as the workpiece.

11. A non-transitory computer readable medium storing a program causing a computer to execute a process for processing information, the process comprising:
when a processing procedure including a plurality of processing steps to process a workpiece has been produced, causing to be displayable, on a display, pre-process information indicating the workpiece and post-process information indicating a product obtained when the processing procedure is performed on the workpiece.

12. An information processing method comprising:
when a processing procedure including a plurality of processing steps to process a workpiece has been produced, causing to be displayable, on a display, pre-process information indicating the workpiece and post-process information indicating a product obtained when the processing procedure is performed on the workpiece.
